(19) United States
(12) Patent Application Publication
(10) Pub. No.: US 2011/0214644 A1
(43) Pub. Date: Sep. 8, 2011

(54) Cold-Start Fuel Control System

(75) Inventors: Jason C. Barta, Loveland, CO (US); Michael W. Bloemen, Fort Collins, CO (US); Stephan M. Brandl, Fort Collins, CO (US)

(73) Assignee: WOODWARD, INC., Fort Collins, CO (US)

(21) Appl. No.: 13/034,033

(22) Filed: Feb. 24, 2011

Related U.S. Application Data
(60) Provisional application No. 61/311,092, filed on Mar. 5, 2010.

(51) Int. Cl. F02M 37/04

(52) U.S. Cl. 123/512

(57) ABSTRACT

A fuel control system for controlling the supply of liquefied petroleum gas (LPG) to injectors of a fuel supply system during a cold start is provided. The fuel control system includes a LPG pressure regulator and a cold-start fuel control valve for throttling fuel to the injectors when the pressure of the LPG is below a nominal set point pressure of the pressure regulator. The cold-start fuel control valve may be in parallel or series with a fuel lock-off valve. The system is configured to supply limited discrete amounts of LPG to the injectors when the pressure of the LPG is below the nominal set point pressure to allow the LPG to vaporize prior to being injected, by the injector, into an engine. Operation of the cold-start fuel control valve during non-cold starts and normal operation are also provided.

### CROSS-REFERENCE TO RELATED PATENT APPLICATION

This patent application claims the benefit of U.S. Provisional Patent Application No. 61/311,092, filed Mar. 5, 2010, the entire teachings and disclosure of which are incorporated herein by reference thereto.

### FIELD OF THE INVENTION

This invention generally relates to fuel control systems and particularly fuel control systems configured to improve cold starting of combustion engines and more particularly combustion engines that use liquefied petroleum gas (LPG).

### BACKGROUND OF THE INVENTION

Liquefied petroleum gas (LPG) used on mobile applications is often stored in a saturated liquid state in a tank or bottle and the fuel is fed to the fuel control system as a liquid. The pressure of the liquid being fed to the system is directly dependent on the temperature of the fuel in the tank and the composition of the fuel.

If the tank pressure is lower than the systems nominal set point (e.g. the pressure at which it is to be supplied to the fuel injectors during normal operation), the pressure regulator upstream of the fuel injectors will not be active. This is because the pressure will already be lower than the nominal set point to which the pressure regulator is configured to drop the pressure of the fuel. As such, liquid fuel will be introduced to the injectors and the engine will not be able to start due to an extremely fuel rich fuel-to-air mixture within the combustion chamber. This is compounded by the fact that most LPG fuels have a liquid density of approximately 150-200 times greater than the vapor density.

This is generally a problem when high amounts of butane are present in the fuel, the ambient temperature is cold, the fuel is cold, the engine is cold, and/or a high-pressure injection system is used. As such, this becomes a particular problem when vehicles are stored outside during cold winter months.

Traditionally, the way to solve the problem is to adjust the fuel system pressure nominal set point to be below the vapor pressure of the fuel in the tank. This can be achieved on existing systems by manually adjusting the fuel pressure setting. However, if a system uses this manual adjustment method, doing so may require other changes to the system hardware to increase fuel flow (i.e. adding additional injectors to the system, larger injectors, other additional hardware) to avoid adverse affects to system performance such as reduced maximum engine power due to restricted fuel flow from reduced pressure, reduced transient response from lower system pressure, poorer fuel control, loss of the ability to seal the system, etc.

Embodiments of the present invention provide a system that avoids the need to adjust the fuel system pressure nominal set point to initiate cold starting an internal combustion engine when the fuel pressure is below the pressure nominal set point of the system when operating at standard conditions.

### BRIEF SUMMARY OF THE INVENTION

In view of the above, embodiments of the present invention provide a new and improved liquefied petroleum gas (LPG) fuel control system for controlling fuel supplied to an engine from an LPG tank that overcomes one or more problems existing in the art. The system provides improved cold-start operation to avoid flooding the engine due to failure to vaporize the LPG prior to passing the LPG through downstream injectors.

An embodiment of the present invention will allow the system to automatically compensate for different fuel blends by restricting the flow of liquid fuel to result in a predetermined fuel pressure set point independent of the nominal fuel pressure setting during cold-start operations. Such an embodiment also allows the system to adapt to changing conditions in order to optimize system performance such as to increase fuel flow due to increased temperature of the system and particularly the fuel passing therethrough. Other injection systems would require manual changes to the system pressure setting and possibly other hardware configurations to achieve the desired system performance over the full operating range.

In one embodiment, the system utilizes a cold-start fuel control valve fluidly upstream of the pressure regulator during cold-start operations to throttle the supply of liquid LPG to the downstream system, and particularly the injectors, to regulate pressure of the liquid LPG to permit the LPG to vaporize.

In more particular embodiments, the system may include a fuel lock-off valve that is coupled in series or parallel with the cold-start fuel control valve. The fuel lock-off valve will typically be controlled by an electronic controller of the system only between fully open or closed positions. In more particular embodiments, the fuel lock-off valve has a first orifice having a first flow area and the cold-start fuel control valve has a second orifice having a second flow area being smaller that the first flow area. Even more particular embodiments have first flow area defined by a first orifice diameter that is between about 2 and 6 times greater than a second orifice diameter defining the second flow area.

In one embodiment, the first flow area is defined by a first diameter of between about 0.2 and 0.3 inches and the second flow area is defined by a second diameter of between about 0.05 and 0.1 inches.

In one embodiment, the system includes a controller operably coupled to the cold-start fuel control valve and at least one sensor for sensing at least one characteristic of the LPG. The controller operably controls the cold-start fuel control valve based on the characteristic of the LPG. In a more particular embodiment, the controller is coupled to a temperature sensor and a pressure sensor for sensing the temperature and pressure of the LPG downstream of the cold-start fuel control valve. In more particular embodiments, the controller is further coupled to an engine coolant temperature sensor. The controller controls the cold-start fuel control valve based on the temperature and pressure of the LPG downstream of the fuel control valve as well as the temperature of the engine coolant. The controller is configured to operate in a cold-start assist mode only when the temperature and pressure of the LPG, as well as the temperature of the engine coolant, are below respective thresholds.

In one embodiment, at least one LPG injector is downstream of the pressure regulator with the temperature and pressure sensors being upstream of the injector. An injector arrangement can be used which could be one or more injectors.

In one embodiment, the system includes at least one LPG injector downstream of the pressure regulator. The controller is configured to have a cold-start assist mode. The controller is configured to open the cold-start fuel control valve for a predetermined period of time to allow a discrete amount of LPG to pass through the cold-start fuel control valve. The controller is configured then to close the cold-start fuel control valve until a pressure of the LPG between the LPG injector and the cold-start fuel control valve drops below a predetermined cold-start pressure minimum. The controller is configured again to open the cold-start fuel control valve to allow a second discrete amount of LPG to pass through the cold-start fuel control valve at which time the controller closes the cold-start fuel control valve. The discrete amounts of LPG are sufficiently low to keep the pressure low enough to permit vaporization of the LPG during cold-start conditions (cold-start conditions being those conditions that render the LPG pressure regulator inoperable such that the LPG will not vaporize as it passes through the LPG pressure regulator). The portion of the system where the discrete amount of LPG sits as it is vaporized prior to passing through the injector may be referred to as a sampling portion.

In another embodiment, operation of the cold-start fuel control valve may be continued during normal operation of the engine. In such an embodiment, the cold-start fuel control valve functions during such normal operation to control the pressure of the LPG, and as such eliminates the need for an LPG pressure regulator. Preferably, such an embodiment includes a heat exchanger to perform the same function as the heat exchanger portion of the LPG pressure regulator in other embodiments.

A method of starting an engine operating on a liquefied petroleum gas using a fuel control system having a pressure regulator and a cold-start fuel control valve upstream of the pressure regulator includes the following steps. First, the system samples the temperature and pressure of the LPG to determine if cold-start assist is needed. This is determined when the temperature and pressure of the LPG are both below respective predetermined thresholds. The method also includes the step of supplying only a discrete amount of LPG to an injector arrangement of the system downstream of a cold-start fuel control valve if cold-start assist is needed. This prevents the system from supplying liquid LPG to the injector arrangement. This step of supplying a discrete amount of LPG to an injector arrangement, i.e. downstream of the cold-start assist valve, can also be used to provide the LPG for sampling the LPG temperature and pressure to determine if the cold-start assist is needed.

During cold start assist operations, the method may also include the step of monitoring the pressure of the discrete amount of LPG supplied to the injector arrangement and then supplying a second discrete amount of LPG to the injector arrangement when the pressure of the discrete amount of LPG supplied to the injector arrangement is below a predetermined cold-start pressure minimum.

A further method may include the step of sampling the engine coolant temperature during the step of sampling the temperature and pressure of the LPG and determining that cold-start is needed when the engine coolant temperature is below a engine coolant temperature threshold.

Additional methods in accordance with the present invention may include, after determining that cold-start assist is needed, the step of sampling the temperature and pressure of the LPG. More particular methods may include, ending the cold-start assist when either the temperature or pressure of the LPG is above the respective thresholds. When engine coolant temperature is monitored, cold-start assist could end when either the temperature of the LPG, the pressure of the LPG or the temperature of the engine coolant is above the respective thresholds.

This sampling of the temperature and pressure of the LPG allows the system to automatically compensate for different fuel blends by restricting the flow of liquid fuel to result in a predetermined cold-start fuel pressure set point independent of the nominal fuel pressure setting provided by the LPG pressure regulator. This also allows the system to adapt to changing conditions in order to optimize system performance by analyzing changes in the LPG characteristics, such as vapor pressure.

In another embodiment, the method performed during initial cold-start of the engine is continued during normal running of the engine. In such a method, the operation of the cold-start fuel control valve controls the pressure of the LPG, and therefore the LPG pressure regulator may be eliminated.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of a first embodiment of an engine coupled to a fuel control system according to an embodiment of the present invention configured to provide cold-start assist having a cold-start fuel control valve in series with a fuel lock-off valve;

FIG. 2 is a schematic illustration of a second embodiment of an engine coupled to a fuel control system according to an embodiment of the present invention configured to provide cold-start assist having a cold-start fuel control valve in parallel with a fuel lock-off valve;

FIG. 3 is a simplified flowchart illustrating various steps the fuel control system of FIGS. 1 and 2 performs during initial startup of an engine according to an embodiment of the present invention; and

FIG. 4 is a schematic illustration of a third embodiment of an engine coupled to a fuel control system according to an embodiment of the present invention configured to provide cold-start assist and normal engine running regulated by a cold-start fuel control valve without a separate pressure regulator.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

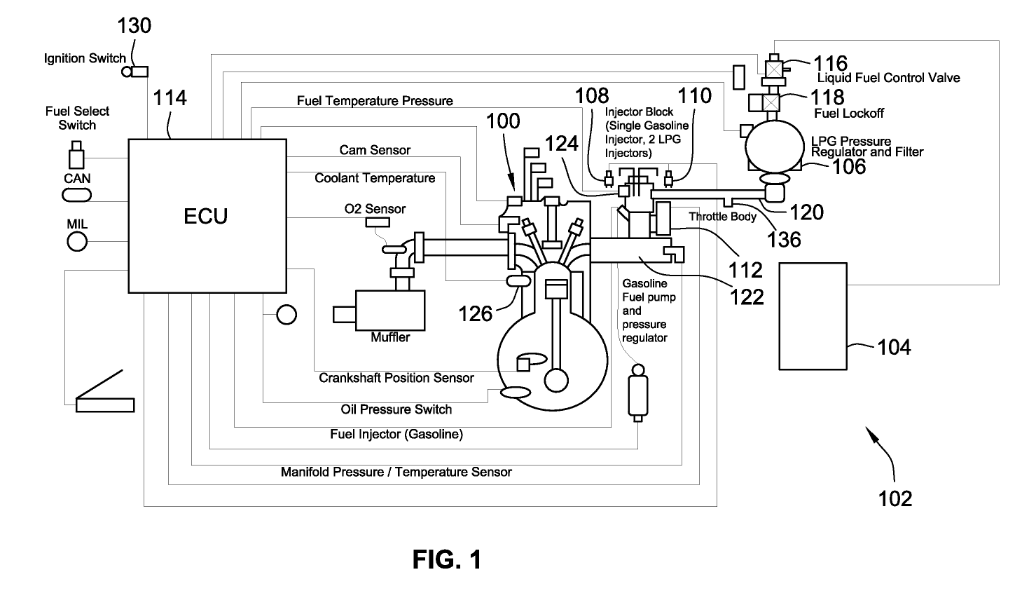

FIG. 1 is a schematic representation of an exemplary embodiment of a engine 100 having a fuel control system 102 according to an embodiment of the present invention. The fuel control system 102 controls the supply of fuel to the engine 100 from a storage tank 104 (also referred to as a bottle) to maximize engine performance. This is accomplished by providing optimum fuel-to-air ratios based on various engine parameters such as fuel temperature, fuel pressure, engine temperature, crankshaft position, intake manifold pressure, etc. In the illustrated embodiment, the primary fuel supplied to the engine 100 is liquefied petroleum gas (LPG) stored in tank 104.

The present system is configured to overcome the long standing problems associated with cold-starting engines using LPG. More particularly, the system avoids the need to adjust the nominal set point pressure of the LPG pressure regulator 106 to a lower value during cold-starting to promote vaporization of the LPG prior to the LPG being supplied to the fuel injectors 108, 110.

The fuel injectors 108, 110 of the present system are configured to control the fuel flow of an upstream vapor LPG rather than a liquid LPG. This is particularly due to the fact that liquid LPG has a density of approximately 200 times that of vapor LPG. As such, if the injectors are configured to operate using vapor LPG. If they inject the same volume of a liquid LPG, they would be injecting 200 times too much LPG into throttle body 112 causing an extremely high fuel rich fuel-to-air mixture such that the fuel will not combust within engine 100 preventing the engine 100 from running.

With that brief introduction, the operation of the system illustrated in FIG. 1 will be more fully described.

The fuel control system 102 includes an electronic control unit (ECU) 114 that is connected to a plurality of sensors and devices for monitoring the engine and other system parameters and then for controlling operation of engine 100 based on those parameters. One particular function of the ECU 114 in the illustrated embodiment is to control the rate at which LPG is supplied to engine 100 or if fuel is even able to be supplied to engine 100. The fuel control system 102 of the illustrated embodiment of the present invention, and particularly the ECU 114, is configured to have a cold-start assist mode to assist starting the engine 100 during cold-start conditions.

To this end, the fuel control system 102 includes a cold-start fuel control valve 116 operably coupled to and controlled by ECU 114. The cold-start fuel control valve 116 is used to control fuel flow during cold-start operations as will be more fully described below. A fuel lock-off valve 118 is arranged in series with and downstream of the cold-start fuel control valve 116. The fuel lock-off valve 118 is used to provide a means for quickly and completely shutting off fuel flow from tank 104 to engine 100 due to stoppage of the engine or for safety reasons.

In typical arrangements, the fuel lock-off valve 118 will have an orifice diameter that is between 2-6 times greater than the orifice diameter of the cold-start fuel control valve 116, which may result in a flow area that is 4-36 times greater. For example, in one embodiment, the orifice diameter of the fuel lock-off valve 118 is between about 0.2 inch and 0.3 inch and more preferably about 0.25 inch while the cold-start fuel control valve 116 has an orifice diameter of between about 0.05 inch and 0.1 inch and more preferably about 0.0625 inch.

A further distinction between the fuel lock-off valve 118 and the cold-start fuel control valve 116 is that the fuel lock-off valve 118 is typically configured to be a two state valve that only operates between fully open or fully closed while the cold-start fuel control valve 116 is configured to operate in a plurality of states between being fully open and fully closed to adjust fuel flow therethrough rather than being configured simply to allow no flow or full flow as is the case with the fuel lock-off valve 118.

Both, the cold-start fuel control valve 116 and the fuel lock-off valve 118, are interposed between LPG pressure regulator 106 and fuel tank 104. As noted, this system has both valves 116, 118 in series. As such, all LPG that flows from the tank to engine 100 must pass through both valves 116, 118. Injectors 108, 110 are shown external to throttle body 112 for schematic purposes. Further, injectors 108, 110 are fluidly connected to LPG pressure regulator 106 via fuel flow conduit 120 which fluidly couples LPG pressure regulator 106 with throttle body 112. After the LPG is mixed with air, the fuel-air mixture passes to the engine through intake manifold 122.

In some embodiments, the fuel flow conduit 120 may be coupled to or formed as part of a distribution block (also referred to as a fuel rail) interposed between the injectors and the LPG pressure regulator 106. The fuel then flows from such a distribution block to the injectors. The injectors may be mounted to the throttle body 112 or to an adapter above the throttle body 112.

The flow path from the LPG pressure regulator 106 to the injectors 108, 110 may include a liquid accumulator, illustrated in the form of collection sump 136. This liquid accumulator increases the volume of the flow path between the LPG pressure regulator 106 and injectors 108, 110 to assist in vaporization of liquid LPG during cold-start assist operations. In other embodiments, the liquid accumulator could take other forms such as a coalescing filter. Preferably, the liquid accumulator is also configured and arranged to prevent liquid LPG from flowing along the flow path to the injectors 108, 110. The liquid accumulator may include a drain valve or other means for emptying the accumulator at various maintenance periods.

The primary issue with cold-starting is that as temperature of LPG drops so does the vapor pressure. In cold-starting operations, the vapor pressure of the LPG may be below a nominal set point pressure of LPG pressure regulator 106 such that the LPG pressure regulator 106 is inoperable to cause the LPG to vaporize into a vapor as discussed above. As such, the LPG will pass right through LPG pressure regulator 106 in liquid form to throttle body 112 and more particularly the injectors 108, 110 therein causing the fuel-rich problems discussed previously.

In one embodiment of the present invention, the system uses a fuel pressure sensor and a fuel temperature sensor (illustrated as fuel pressure/temperature sensor 124) along with an engine coolant temperature sensor 126 to determine if cold-start assist is need. If the cold-start assist is needed, the present system addresses this cold start problem by throttling the liquid LPG that enters the system as will be discussed more fully below.

The throttling of the liquid LPG will control fuel pressure to a pre-determined cold-start set point until such throttling is no longer needed by controlling the cold-start fuel control valve 116. The throttling is accomplished by repeatedly allowing limited discrete amounts of liquid LPG to pass through the cold-start fuel control valve 116.

The ECU 114 initiates cold-start operations as well as controls the cold-start fuel control valve 116 during cold-start operations based on the fuel temperature and pressure as well as the engine coolant temperature. In one embodiment, if any of the sensed values of the relevant parameters, e.g. engine coolant temperature, the fuel temperature or the fuel pressure, are greater than predetermined values, the system will not enter the cold-start assist mode and the system will operate normally such that the system relies on the LPG pressure regulator 106 to control vaporization of the LPG based on the nominal set point pressure of the LPG pressure regulator 106.

However, if all of the relevant parameters are below predetermined threshold values, the system will begin operation using a cold-start assist mode. Once the engine 100 is started via the cold-start assist mode and is operating, a heat exchanger in the LPG pressure regulator 106 is able to heat the liquid LPG. Once the engine 100 heats sufficiently such that the heat exchanger in the LPG pressure regulator 106 is able adequately to raise the fuel temperature such that the vapor pressure of the LPG is greater than the nominal set point pressure of the LPG pressure regulator 106, the cold-start assist is no longer needed.

During cold-start assist mode, the ECU 114 will control the cold-start fuel control valve 116 to allow a limited and typically discrete amount of liquid through the cold-start fuel control valve 116 and into the portion of the system between the injectors 108, 110 and the cold-start fuel control valve 116. During cold start assist, a predetermined cold-start pressure within the system downstream of the cold-start fuel control valve 116 should not be exceeded to prevent the LPG from being maintained in the liquid state. This cold-start pressure will be below the vapor pressure of the LPG as well as the nominal set point pressure of the LPG pressure regulator 106.

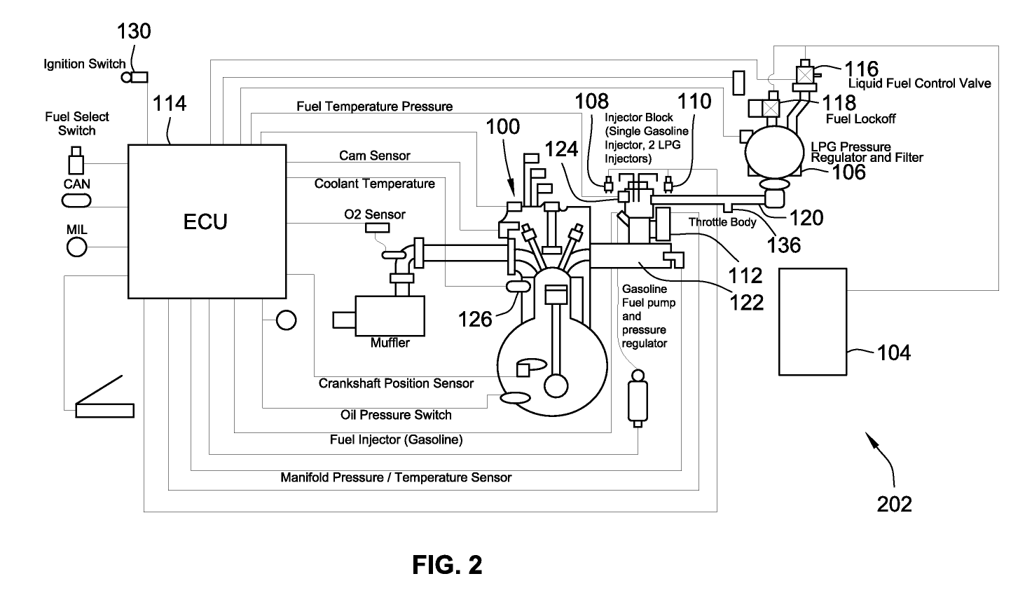

FIG. 2 is a schematic illustration of an alternative embodiment of the present invention. This embodiment is substantially similar to the previous embodiment except that the cold-start fuel control valve 216 and the fuel lock-off valve 218 are positioned in parallel with one another such that LPG can be independently supplied through either the cold-start fuel control valve 216 or the fuel lock-off valve 218 depending on the particular operating mode of the system.

This parallel arrangement provides the advantage that the cold-start fuel control valve 216 can be independently configured without concern of any reduction in engine power due to undue flow restriction due to the small orifice of the cold-start fuel control valve 216 during normal, non-cold start assist, operation. In this configuration, the cold-start fuel control valve 216 need not have sufficient control resolution to allow enough flow to obtain desired maximum levels of engine power. The cold-start fuel control valve 216 need only be configured, and therefore optimized, for cold-start assist mode.

During operation of this system, the lock-off valve 218 remains closed during all cold-start operation and only opens after the fuel control system 202 has determined that cold-start assist need not occur or need no longer occur. The fuel lock-off valve 218 must remain closed until normal operation to prevent LPG to bypass the cold-start fuel control valve allowing the downstream portion of the system to fill with liquid LPG during cold start operations. Once the engine 100 has warmed sufficiently, the fuel lock-off valve 218 would open to allow standard fuel flow to the system and the cold-start fuel control valve 216 could be left open or closed as desired. In a preferred embodiment, the cold-start fuel control valve 216 is closed so that closure of the fuel lock-off valve 218 will result in the engine stopping operation.

It should be noted that while both the embodiments shown in FIGS. 1 and 2 are illustrated in a hybrid system that can run on both gasoline as well as LPG, embodiments of the present invention may be used in systems that are strictly dedicated to LPG. As such, these illustrations should be taken by way of example and not by way of limitation. Further, while the schematic illustrations of FIGS. 1 and 2 illustrate schematic systems that utilize throttle body injection systems, other embodiments of the invention may be used in port injection systems that do not use a central throttle body injection.

In some embodiments, e.g. those similar to that shown in FIG. 1, the cold-start fuel control valve 116 is configured to have sufficient control resolution to start the engine 100 during cold start situations, but, because the cold-start fuel control valve 116 in this embodiment is in series with the fuel lock-off valve 118, it must be able permit a sufficient flow of fuel during normal operation to reach maximum engine power.

The cold-start fuel control valve 116 could be either a solenoid valve or a proportional actuator with a small orifice. However, the concept is not limited to a solenoid valve or proportional actuator, any type of valve could be used that can give system the necessary control over the amount of liquid that enters the system.

In some embodiments, the cold-start fuel control valve 116 can be used in lieu of the fuel lock-off valve shown in FIG. 1. However, in other embodiments the solenoid valve/actuator resides directly upstream of the fuel lock-off valve 118 shown in FIG. 1 or in parallel therewith as shown in FIG. 2 as these allow for easily adapting existing systems to include this cold-start assist. This is particularly useful in systems which have fuel lock-off valves or controllers that do not have sufficient resolution or control to provide for the variations in flow necessary to provide for the cold-start assist.

In preferred embodiments, the fuel temperature/pressure sensor 124 resides downstream from the LPG pressure regulator 106 but upstream from injectors 108, 110. This allows for standard systems that already include these sensors to be used without requiring additional sensors to be added to the system. However, in other embodiments, some of the sensors for gathering information regarding the LPG could be upstream of the cold-start fuel control valve 116.

The discrete amounts of liquid LPG that are permitted to pass through the cold-start fuel control valve 116 can be varied based on the sensed parameters of the engine and particularly the three primary parameters of fuel temperature and fuel pressure sensed by sensor 124 and engine coolant temperature sensed by sensor 126. More particularly, as the fuel temperature increases and/or engine coolant temperature increases, more liquid LPG may be permitted to pass through cold-start fuel control valve 116.

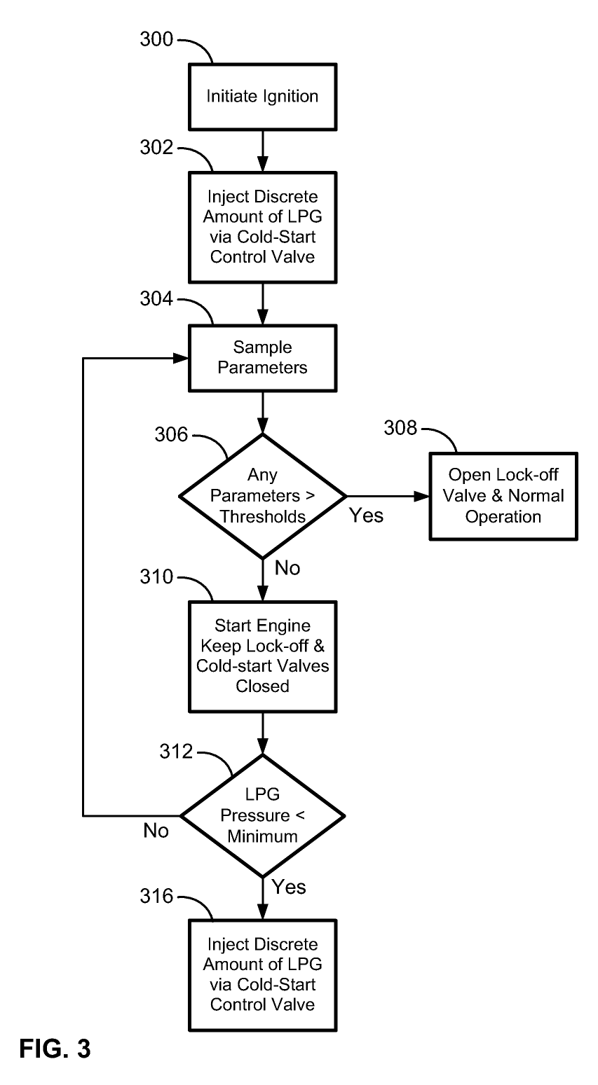

Turning now to FIG. 3, operation of the systems of the present invention illustrated above will be described. To begin, an attempt to initiate ignition of the engine at step 300 occurs. Typically, this is performed when the operator turns the key on (e.g. at ignition switch 130 of FIGS. 1 and 2). In the following steps, the system will check to see if cold-start assist mode is needed.

Specifically, at step 302 the ECU 114 opens the fuel lock-off valve 118 (in the embodiment of FIG. 1 but not in the embodiment of FIG. 2) and then or simultaneously opens the cold-start fuel control valve 116 to allow a small amount of liquid LPG to enter or otherwise be injected into the system downstream thereof. The system will then sample at step 304 the particular engine and fuel parameters or characteristics using the engine sensors along with the fuel pressure/temperature sensor 124 and/or the coolant temperature sensor 126. These values will then be compared with predetermined thresholds at step 306 to determine if the cold start assist is needed.

If any of the parameters is greater than that parameter's threshold, the system will determine that cold-start assist is not needed and the system will operate normally as indicated by step 308. In the embodiment of FIG. 1, both the cold-start fuel control valve 116 and the fuel lock-off valve 118 will be opened. In the embodiment of FIG. 2, the cold-start fuel control valve 216 will be kept closed (or may be opened as discussed above) and the fuel lock-off valve 218 will be opened.

If, however, at step 306 it is determined that all of the parameters are below the predetermined thresholds, i.e. the fuel is too cold, the fuel pressure is too low and, in one embodiment, the engine coolant temperature is too low, the system will determine that cold-start assist mode is needed.

In some embodiments and as illustrated as step 310, the fuel lock-off valve 118 and/or the cold-start fuel control valve 116 will be disabled for a pre-determined period of time and the engine will be turned-over to allow the system to clear any liquid that may have entered the system during the sample from step 302. However, this is not necessary in all embodiments.

In the cold-start assist mode, the system monitors the LPG pressure at step 312 and, when it is less than the minimum, the ECU 114 will control the cold-start fuel control valve 116 at step 316 to throttle the liquid LPG into the downstream portion of the system. In the embodiment of FIG. 1, the fuel lock-off valve 118 will also be opened since it is in series with the cold-start fuel control valve 116. In one embodiment, the cold-start fuel control valve 116 will open and close to control the fuel pressure by throttling the liquid LPG into the downstream portion of the system to maintain pressure at the desired the cold start set point pressure (e.g. providing repeated small shots of liquid LPG into the downstream portion of the system).

This will continue until the engine sensors and the fuel pressure/temperature sensor 124 indicate that cold-start fuel pressure control is no longer necessary, i.e. the LPG pressure is greater than the minimum cold-start pressure threshold at step 312. At such a point, the LPG pressure regulator 106 will take over pressure control and the system will behave normally based on the nominal set point pressure, illustrated at step 308. This typically occurs once the engine coolant of engine 100 has warmed sufficiently to provide sufficient heat exchange to the liquid LPG to permit vaporization of the LPG within the LPG pressure regulator 106.

As will now be apparent to those skilled in the art from the foregoing description, during cold-start assist the cold-start fuel control valve 116 is operated to repeatedly allow a small, discrete amount of liquid LPG into the system downstream of the cold-start fuel control valve 116 but upstream of injectors 108, 110. In one embodiment, during this time period, the injectors 108, 110 are operated via the ECU 114 under standard operating conditions. More particularly, the injectors 108, 110 are opened and closed (typically using pulse-width-modulation) as needed to provide fuel to the engine 100.

During this cold-start assist, the cold-start fuel control valve 116 remains closed after each predetermined amount of liquid LPG has passed through the cold-start fuel control valve 116 and been injected to the downstream portion of the system. This prevents the downstream portion of the system filling with liquid LPG and flooding the system. If the cold-start fuel control valve 116 were to remain open, the pressure of the LPG within the downstream portion of the system would go to tank pressure. Unfortunately, tank pressure is too great relative to the vapor pressure of the liquid LPG during cold-start conditions and the tank pressure prevents the liquid LPG from vaporizing within the system upstream of injectors 108, 110.

With the cold-start fuel control valve 116 closed and the engine 100 running, the injectors 108, 110 are operated to open and close to permit fuel to be supplied to the engine 100 in vapor form. As the fuel is supplied to engine 100, the predetermined discrete amount of LPG within the system downstream from the cold-start fuel control valve 116 will vaporize and escape through the injectors 108, 110 and be used by the engine 100. The liquid accumulator assists in promoting vaporization of the liquid LPG by providing an increased volume relative to standard systems. The ECU 114 will continue to monitor the system parameters, and most typically the pressure, of the LPG within this downstream portion of the system as discussed above with regard to step 312.

If the ECU 114 determines that cold start assist needs to continue and the pressure within this downstream portion of the system drops too low, e.g. below a cold-start pressure minimum discussed above with regard to step 312, the ECU 114 will cause the cold-start fuel control valve 116 to open again. This will cause another discrete amount of liquid LPG to be injected into the downstream portion of the system 316. However, again, only a limited discrete amount of LPG is permitted to flow into the downstream portion of the system to prevent flooding or conditions that would prevent the liquid LPG from vaporizing. This process will continue to repeat (i.e. opening and closing of the cold-start fuel control valve) until the ECU 114 determines that cold-start assist is no longer needed.

FIG. 3 illustrates that the system will sample the parameters to determine if cold-start assist needs to continue only when the pressure of the LPG is greater than the cold-start pressure minimum. However, the ECU 114 could monitor this independently such that at any moment when the relevant parameters pass the threshold values, normal operation will begin.

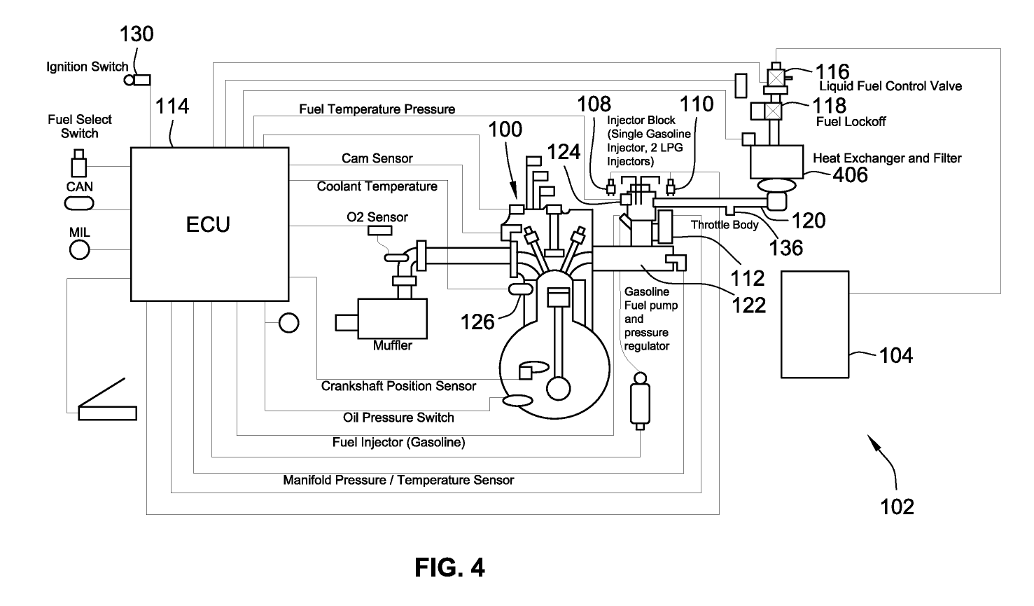

FIG. 4 illustrates a further embodiment of the present invention that utilizes the cold-start fuel control valve 116 not only to provide the cold start assist discussed above, but also to control the LPG pressure during continued, normal operation after engine start without the need for a separate LPG pressure regulator. Such an embodiment utilizes the cold-start fuel control valve 116 to control the pressure of the LPG to the predetermined set point based on the sensed engine parameters during non-cold-starts and normal operation, similar to the cold-start operation discussed above.

Unlike operation in the embodiments discussed above, however, the ECU 114 never decides to turn the cold-start fuel control valve 116 completely on (thus allowing the LPG pressure regulator 106 of FIG. 1 to control LPG pressure) because there is no pressure regulator as in prior embodiments. Instead, the ECU 114 will control the cold-start fuel control valve 116 to allow a limited and typically discrete amount of liquid through the cold-start fuel control valve 116 and into the portion of the system between the injectors 108, 110 and the cold-start fuel control valve 116. This pressure is sensed and the ECU 114 adjusts the throttling rate of the cold-start fuel control valve 116 to maintain the pressure at its predetermined level. In an embodiment, the system includes a heat exchanger 406, which functions similar to the heat exchanger portion of the pressure regulator 106 of FIG. 1 discussed above.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A liquefied petroleum gas (LPG) fuel control system for controlling fuel supplied to an engine from an LPG tank, the fuel control system comprising:
a pressure regulator; and
a cold-start fuel control valve fluidly coupled to the pressure regulator upstream of the pressure regulator.

2. The fuel control system of claim 1, further comprising a fuel lock-off valve fluidly coupled to the pressure regulator upstream of the pressure regulator.

3. The fuel control system of claim 2, wherein the fuel lock-off valve has a first orifice having a first flow area and the cold-start fuel control valve has a second orifice having a second flow area being smaller that the first flow area.

4. The fuel control system of claim 3, wherein the first flow area is defined by a first diameter being between about 3 and 36 times greater than a second diameter defining the second flow area.

5. The fuel control system of claim 3, wherein the first flow area is defined by a first diameter of between about 0.2 and 0.3 inches and wherein the second flow area is defined by a second diameter of between about 0.05 and 0.1 inches.

6. The fuel control system of claim 2, wherein the fuel lock-off valve and the cold-start fuel control valve are arranged in parallel.

7. The fuel control system of claim 2, wherein the fuel lock-off valve and the cold-start fuel control valve are arranged in series.

8. The fuel control system of claim 7, wherein the fuel lock-off valve is interposed fluidly between the pressure regulator and the cold-start fuel control valve.

9. The fuel control system of claim 1, further comprising a controller operably coupled to the cold-start fuel control valve and at least one sensor for sensing at least one characteristic of the LPG, the controller programmed to control the cold-start fuel control valve based on the characteristic of the LPG.

10. The fuel control system of claim 9, wherein the controller is coupled to a temperature sensor and a pressure sensor for sensing the temperature and pressure downstream of the cold-start fuel control valve.

11. The fuel control system of claim 10, wherein the controller is further coupled to an engine coolant temperature sensor, the controller being programmed to control the cold-start fuel control valve based on the temperature and pressure downstream of the fuel control valve and the temperature of the engine coolant.

12. The fuel control system of claim 10, further comprising at least one LPG injector downstream of the pressure regulator, wherein the controller is configured to have a cold-start assist mode, the controller being configured to open the cold-start fuel control valve for a predetermined period of time to allow a discrete amount of LPG to pass through the cold-start fuel control valve, the controller configured to maintain the cold-start fuel control valve closed thereafter until a pressure of the LPG between the LPG injector and the cold-start fuel control valve drops below a predetermined cold-start pressure minimum, the controller being configured to again open the cold-start fuel control valve to allow a second discrete amount of LPG to pass through the cold-start fuel control valve after which the controller closes the cold-start fuel control valve, the discrete amounts of LPG being sufficiently low to keep the pressure low enough to permit vaporization of the LPG.

13. The fuel control system of claim 6, further comprising a controller operably coupled to the cold-start fuel control valve and a sensor for sensing a characteristic of the LPG, the controller operably controlling the cold-start fuel control valve based on the characteristic of the LPG, wherein the controller is operably coupled to the fuel lock-off valve and wherein during a cold-start assist mode, the controller keeps the fuel lock-off valve closed.

14. The fuel control system of claim 7, further comprising a controller operably coupled to the cold-start fuel control valve and a sensor for sensing a characteristic of the LPG, the controller operably controlling the cold-start fuel control valve based on the characteristic of the LPG, wherein the controller is operably coupled to the fuel lock-off valve and wherein during a cold-start assist mode, the controller keeps the fuel lock-off valve open.

15. The fuel control system of claim 10, further comprising at least one LPG injector downstream of the pressure regulator, the temperature and pressure sensors being upstream of the injector.

16. The fuel control system of claim 12, wherein the cold-start assist mode occurs when the vapor pressure of the LPG is less than a nominal set point pressure of the pressure regulator.

17. The fuel control system of claim 12, wherein the controller is configured to repeat injecting discrete amounts of LPG between the cold-start fuel control valve and the at least one injector until at least one of a LPG temperature of the LPG downstream of the cold-start fuel control valve, a pressure of the LPG downstream of the cold-start fuel control valve or a temperature of coolant of the engine exceeds a threshold value.

18. A liquefied petroleum gas (LPG) fuel control system for controlling fuel supplied to an engine from an LPG tank, the fuel control system comprising:
a cold-start fuel control valve;
an injector downstream of the cold-start fuel control valve;
a first temperature sensor for sensing a temperature of the LPG;
a pressure sensor for sensing a pressure of the LPG;
a controller coupled to the first temperature sensor, the pressure sensor and the cold-start fuel control valve, the controller configured to inject a first discrete amount of LPG into a sampling portion of the system, the sampling portion of the system being between the cold-start fuel control valve and the injector.

19. The fuel control system of claim 18, wherein the controller is configured to operate in a cold-start assist mode if the parameter is below a threshold value, the controller opens the cold-start fuel control valve to inject a second discrete amount of LPG into the sampling portion of the system when the pressure within the sampling portion of the system drops below a cold-start pressure minimum.

20. The fuel control system of claim 19, further comprising a pressure regulator interposed between the cold-start fuel control valve and the sampling portion, and wherein the controller is configured to open the cold-start fuel control valve and allow the pressure regulator to regulate the pressure of the LPG once at least one of the pressure of the LPG or the temperature of the LPG exceeds a respective predetermined threshold.

21. The fuel control system of claim 18, wherein the controller is configured to operate in a non-cold-start assist mode if the parameter is above a threshold value, the controller throttling the cold-start fuel control valve to inject discrete amounts of LPG into the sampling portion of the system to maintain the pressure within the sampling portion of the system at a predetermined threshold.

22. The fuel control system of claim 21, further comprising a heat exchanger interposed between the cold-start fuel control valve and the sampling portion, and wherein the controller is configured to throttle the cold-start fuel control valve to regulate the pressure of the LPG.

23. The fuel control system of claim 21, wherein the controller is configured to throttle the cold-start fuel control valve to regulate the pressure of the LPG.

24. A method of starting an engine operating on a liquefied petroleum gas using a fuel control system, the method comprising:
sampling the temperature and pressure of the LPG;
determining that cold-start assist is needed when the temperature and pressure of the LPG are both below respective predetermined thresholds;
supplying only a discrete amount of LPG to an injector arrangement of the system downstream of a cold-start fuel control valve if cold-start assist is needed to prevent supplying liquid LPG to the injector arrangement.

25. The method of claim 24 further comprising the step of monitoring the pressure of the discrete amount of LPG supplied to the injector arrangement and then supplying a second discrete amount of LPG to the injector arrangement when the pressure of the discrete amount of LPG supplied to the injector arrangement is below a predetermined cold-start pressure minimum.

26. The method of claim 25 further comprising the step of sampling the engine coolant temperature during the step of sampling the temperature and pressure of the LPG and determining that cold-start is needed when the engine coolant temperature is below a engine coolant temperature threshold.

27. The method of claim 25 further comprising, after determining that cold-start assist is needed, the step of sampling the temperature and pressure of the LPG.

28. The method of claim 27 wherein the fuel control system includes a pressure regulator, further comprising the step of ending the cold-start assist when either the temperature or pressure of the LPG is above the respective thresholds.

29. The method of claim 26 wherein the fuel control system includes a pressure regulator, further comprising the step of ending the cold-start assist when either the temperature of the LPG, the pressure of the LPG or the temperature of the engine coolant is above the respective thresholds.

30. The method of claim 24, further comprising the steps of:
determining that cold-start assist is not needed when at least one of the temperature or pressure of the LPG is above respective predetermined thresholds;
throttling the cold-start fuel control valve to supply only discrete amounts of LPG to an injector arrangement of the system downstream of the cold-start fuel control valve to control the pressure of the LPG to the injector arrangement at a predetermined threshold.
